(19) United States
(12) Patent Application Publication
(10) Pub. No.: US 2002/0130988 A1
(43) Pub. Date: Sep. 19, 2002

(54) Electrically controllable, variable reflecting element

(76) Inventors: Gregory P. Crawford, Providence, RI (US); Christopher C. Bowley, Woodbury, MN (US); Sadeg M. Faris, Pleasantville, NY (US)

Correspondence Address: Mary Rose Scozzafava, Esq., Hale and Dorr LLP, 60 State Street, Boston, MA, 02109, US

(21) Appl. No.: 09/765,880

(22) Filed: Jan. 18, 2001

(51) Int. Cl. G02F 1/1333; G02F 1/1335

(52) U.S. Cl. 349/86; 349/113

(57) ABSTRACT

A reflecting device having electrically controllable variable reflection is provided having a periodic array of liquid crystals disposed in a polymer matrix, the liquid crystal having an index of refraction variable in response to an applied electric field, and means for applying an electric field across the device to provide first and second applied electric field strengths. The index of refraction of the liquid crystal and the index of refraction of the polymer matrix, nₚ, are mismatched at the first and second applied electric field strengths to provide differing peak wavelengths.

### BACKGROUND OF THE INVENTION

This invention relates to holographically-formed polymer dispersed liquid crystals (H-PDLCs). In particular, the invention relates to reflective H-PDLC displays that reflect at different wavelengths and bandwidths under operator-controllable conditions.

The use of holograms, Bragg gratings and diffractive optical elements in the photonics industry is extensive. Applications using passive holograms include optical films for electronic displays, spectrographic instruments, optical interconnects, and fiber optical communication links.

Liquid crystal polymer dispersions formed under holographic conditions offer a new type of active holographic device—electrically switchable Bragg gratings (ESBGs). These materials alternatively are called holographic polymer dispersed liquid crystals (H-PDLCs). Reflective liquid crystal displays have been developed that rely on H-PDLC materials, in which holographic or optical interference preparative techniques are employed to carry out polymerization to selectively position regions of liquid crystal and polymer in a polymer film. On exposure to an optical interference pattern, typically formed by two coherent lasers, polymerization is initiated in the light fringes. A monomer diffusion gradient is established as the monomer is polymerized in the light fringes, causing diffusion of liquid crystal to the dark fringes. The result is LC-rich areas where the dark fringes were located and essentially pure polymer regions where the light fringes were located.

Planes of liquid crystal droplets are formed within the sample to modulate the LC droplet density on the order of the wavelength of light. The resulting optical interference pattern reflects at the Bragg wavelength, λ=2nd sinθ, where n is the average index of refraction, θ is the angle between the substrate and viewing direction, and d is the Bragg layer spacing. The interference pattern can be selected to form Bragg gratings that can reflect any light of any wavelength.

Usually, the material is formed as a thin film between two conducting indium-tin-oxide (ITO)-coated glass substrates, across which an electric field can be applied to induce the desired electro-optical effect. In the “off state”, that is, with no applied voltage, the liquid crystals are misaligned and light of the Bragg wavelength is reflected back to the observer. Upon application of an applied voltage, the “on state”, the liquid crystals are oriented in the electric field, the incident light is transmitted, and the device becomes transparent.

Due to the small droplet size, H-PDLC films typically display excellent optical properties, with low scattering and absorption through the visible and near IR, and diffraction efficiencies comparable to commercial photopolymers. Unique among holographic photopolymers is the electro-optic response. Application of an electric field to the film alters the LC directors inside the droplets making it possible—in formulations with properly chosen birefringence and polymer host indices—to index match droplets to polymer, causing the refractive index modulation to vanish optically. The result is a volume hologram or Bragg grating that is reversibly switchable between diffractive and transparent states. The dynamics of nematics encapsulated in nanodroplets allow fast switching speeds, typically 50 μs, and offer a new combination of spatial index modulations approaching 0.1 with switching speeds of 50 μs. Not only simple planar gratings, but also complex holograms and holographic optical elements, including lenses and waveguide gratings, may be switched on and off. By combining switchability with optical functions such as filtering, lensing and holographic imaging, ESBG elements can often reduce the number of components required to perform a system function.

Several groups are currently developing H-PDLC materials for a variety of applications. NT&T in Japan (Tanaka et al., Journal of the SID 2:37 (1994)) and—dpiX² in Palo Alto, Calif. (Crawford et al., Proc. Of the SID XXVII:99 (1996)) are developing these materials for direct-view visual display applications. H-PDLC materials offer bright reflective capability (80% at the Bragg wavelength) and excellent color purity, thereby eliminating the need for a power hungry backlight. Recent improvements in reflection efficiency have been reported by modifying the functionality of the reactive monomers. See, Bowley and Crawford, Applied Physics Letters, 76:2235 (April, 2000).

Sutherland et al, at the Science Applications International Corporation, housed at Wright Patterson Air Force Base, Dayton, Ohio, report on use of H-PDLC materials for switchable transmission holograms (Applied Physics Letters 64:1074 (1994)). Domash et al., at the Foster-Miller Photonics Division in Waltham, Mass., have investigated the use of H-PDLC materials in variable focus lenses and fiber optic switches (SPIE 3207:M97-070 (1998)). Digilens Corporation has applied the ESBG technology to developing telecommunication devices, such as application specific integrated filters (ASIF), lenses (ASIL) and switches (ASIS) (SPIE, 4107(Liquid Crystal V):M00-021 (October, 2000)). However, these materials are capable of switching only in an “off (reflective)-on (transparent)” mode.

There is a need to provide a single layer H-PDLC having variable reflective capacity for constructing a reflective display or telecommunications device that can have a range of wavelength responses. Other photonics applications require switching between two reflective wavelengths, perhaps differing by only a few nanometers. A reflective device exhibiting variable maximum peak intensity and/or bandwidth is desired. Such displays are desirable due to their simplified configuration and because they are reflective at low power and in normal operating environments. Current switching technology does not provide this capability.

Thus there remains a need for a reflective device that can be electrically controllable to provide reflected light of variable wavelength.

### SUMMARY

The present invention provides advancements and improvements in the manufacture of H-PDLC compositions. The selection of liquid crystal and polymer components exhibiting index mismatching at resting and applied potentials has been exploited to provide single layer H-PDLC devices capable of switching between various wavelengths. Rather than a single grating providing reflection at a single wavelength, it is now possible to continuously modify the reflection peak of that single grating by application of a variable voltage.

In one aspect of the invention, a reflecting device having electrically controllable, variable reflection includes a composition having a periodic array of liquid crystal disposed in a polymer matrix and a pair of electrodes positioned to apply an electric field across the composition that is capable of applying first and second applied electric field strengths. The liquid crystal has an index of refraction that is variable in response to an applied electric field, so that the index of refraction of the liquid crystal layer and the index of refraction of the polymer matrix, nₚ, are mismatched at the first and second applied electric field strengths.

In another aspect of the invention, a reflecting device having electrically controllable variable reflection is provided, which includes first and second electrodes having a holographic polymer dispersed liquid crystal (H-PDLC) film disposed therebetween. The H-PDLC film is comprised of layers of liquid crystal and polymer matrix. The liquid crystal layer has a first average index of refraction, (n_{LC})₁, at a first applied electric field strength and a second average index of refraction, (n_{LC})₂, at a second applied electric field strength, wherein the (n_{LC})'s of the liquid crystal and the index of refraction of the polymer matrix, nₚ, are mismatched at both the first and second applied electric field strengths.

In some preferred embodiments, the first applied electric field strength is zero. The second applied electric field strength may be sufficient to substantially align the liquid crystal droplets.

In other embodiments, the device possesses at least two reflection wavelengths, each reflection wavelength associated with a different applied field strength. The liquid crystal may have an ordinary index of refraction, nₒ, and an extraordinary index of refraction, nₑ, and the polymer may have a refractive index, nₚ, and where nₒ≠nₚ. The liquid crystal may have an ordinary index of refraction, nₒ, and an extraordinary index of refraction, nₑ, and the polymer may have a refractive index, nₚ, and where nₑ>nₚ>nₒ.

In another embodiment, the liquid crystal may further include a third (n_{LC}) substantially equal to nₚ at a third applied electric field strength; or the device may possess at least three different color states, each color state associated with a different applied field strength; or the index mismatching conditions may result in a shift in the bandwidth of reflected light, as the device liquid crystal moves from a state having a (n_{LC})₁ to a state having a (n_{LC})₂.

In other embodiments the liquid crystal has a positive or negative dielectric anisotropy or a dielectric anisotropy dependent upon applied field frequency.

In other embodiments, the device is selected from the group consisting of waveguide gratings, switchable lenses, switchable filters, optical add-drop multiplexers and attenuators.

In still other embodiments, the device further includes a power source in electrical communication with the electrodes for generating the electric field. The electrode may comprise a conductive layer in electrical communication with the composition, such as indium titanium oxide (ITO). In other embodiments, electrode comprises a metallic electrode.

In another aspect of the invention, a grating having electrically controllable, variable peak wavelength includes a periodic array of diffractive planes in a supporting matrix. The planes form a grating spaced at a distance on the order of a wavelength of light and have an optical thickness responsive to an applied electric field. First and second electrodes are provided for applying first and second applied electric field strengths across the grating, wherein the first and second electric field strengths alter optical thickness to alter peak wavelength of reflected light.

In still another aspect of the invention, a reflecting device having electrically controllable, variable reflection includes a periodic array of liquid crystals disposed in a polymer matrix, the liquid crystal having an index of refraction variable in response to an applied electric field; and means for applying an electric field across the device to provide first and second applied electric field strengths, wherein index of refraction of the liquid crystal and the index of refraction of the polymer matrix, nₚ, are mismatched at the first and second applied electric field strengths.

In yet another aspect of the invention, a method of varying the optical thickness of a reflecting device includes providing a reflecting device comprising a periodic array of liquid crystal in a polymer matrix, the liquid crystal array having an index of refraction variable in response to an applied electric field; and altering the electric field strength across the H-PDLC film between the first and second applied electrical field strengths, wherein the indices of refraction of the liquid crystal are mismatched with the index of refraction of the polymer matrix at both the first and second applied electrical field strengths.

In one embodiment, the method includes a device comprising first and second substrates having a holographic polymer dispersed liquid crystal (H-PDLC) film disposed therebetween, the H-PDLC film comprised of layers of liquid crystal and polymer matrix.

In other embodiments, the method includes a liquid crystal having an ordinary index of refraction, nₒ, and an extraordinary index of refraction, nₑ, and a polymer having a refractive index, nₚ, and where nₒ≠nₚ.

In other embodiments, the peak wavelength of the reflected light shifts as the liquid crystal moves from a state having a first average index of refraction at the first applied electric field strength to a state having a second average index of refraction at the second applied electric field strength; or the device exhibits a continuum of reflection wavelengths as the applied field strength is varied between the first and second applied field strengths; or the reflection wavelength shifts to lower wavelength as the field strength is increased; or the reflection wavelength shifts to higher wavelength as the field strength is increased; or the bandwidth of reflected light varies as the applied field strength is varied between the first and second applied field strengths.

In some embodiments, the applied field strength is of sufficient strength to align the liquid crystal droplets to an extent sufficient to alter the LC index of refraction. The first applied electric field strength is zero; or the applied electric field strength is in the range of about 0V to 240 V.

In other embodiments, the liquid crystal further comprises a third average index of refraction substantially equal to the index of refraction of the polymer crystal.

In yet another aspect of the invention, a method of modifying reflection characteristics in an H-PDLC reflecting device includes providing a reflecting device comprising first and second substrates having a holographic polymer dispersed liquid crystal (H-PDLC) film disposed therebetween, the H-PDLC film made up of layers of liquid crystal and polymer matrix. The liquid crystal has an average index of refraction, n_{LC}, and the polymer has an index of refraction, nₚ. The electric field strength is altered across the H-PDLC film to vary the index of refraction of the liquid crystal such that the H-PDLC film moves from a first index mismatch condition to a second index mismatch condition, and each index mismatch condition is associated with a characteristic reflection characteristic of the H-PDLC film.

In some embodiments, the step of moving from a first index mismatch condition to a second index mismatch condition comprises moving through an index-matching condition.

In another aspect of the invention, a method of electrically controlling a variable peak wavelength of a grating includes providing a periodic array of diffractive planes in a supporting matrix. The planes form a grating spaced at a distance on the order of a wavelength of light and have an optical index responsive to an applied electric field. First and second electric field strengths are applied to alter the peak wavelength of the grating.

### Definitions

The terms “mismatched” and “index mismatch” are used to indicate a condition in which the refractive indices of the liquid crystal, (n_{LC}), and the matrix polymer, nₚ, are not equal. An appropriately selected liquid crystal possesses a variable refractive index dependent upon the degree of orientation of neumatic directors of the liquid crystals within the droplets with respect to the incident light. Thus, the average liquid crystal index, (n_{LC}) is used to determine an index mismatching condition.

“Average index of refraction” or “(n_{LC})” means the net refractive index of a liquid crystal droplet-rich plane. The average index of refraction takes both the ordinary refractive index (nₒ) and the extraordinary refractive index (nₑ) into consideration and represents the weighted average of the two indices, as well as any residual polymer in that plane.

“Holographic technique”, “holography”, “holographic light”, as those terms are used herein refer to the formation of interfering light patterns in a three dimensional space.

When referring to spectral reflectance and wavelength, it is understood that the peak wavelength represents the peak centered around a peak maximum. Width of the full peak may vary, but typically is the range of 20 nm full-width at half maximum (FWHM) for single grating peaks.

“Alignment of LC droplets” refers to orientation of the neumatic directors within the LC droplets with respect to incident light.

### BRIEF DESCRIPTION OF THE DRAWINGS

The invention is described with reference to the following figures, which are presented for the purpose of illustration only, and which are in no way limiting of the invention, and in which:

FIG. 1 is a schematic view illustrating an H-PDLC material having (A) a reflective grating in the zero-field (“off”) state and (B) demonstrating transmission in the applied-field (“on”) state that is transparent to all wavelengths;

FIG. 2 is a model reflectance vs. wavelength plot for an H-PDLC film of the invention (A) in the “off” state and (B) in the “on” state under index mismatching conditions;

FIG. 3 is a model reflectance vs. wavelength plot for another H-PDLC film of the invention (A) in the “off” state and (B) in the “on” state under index mismatching conditions;

FIG. 4 is a schematic illustration of an apparatus used to fabricate a reflection grating H-PDLC film for use in the invention;

FIG. 5 is a plot of reflectance vs wavelength for a series of potentials ranging from zero volts to 240 V;

FIG. 6 is a plot of reflectance vs applied potential and reflectance vs wavelength to illustrate the shift in peak reflectance associated with a change in applied field strength; and

FIG. 7 is a schematic illustration of an optoelectronic device including the variably controllable reflective device of the invention.

### DETAILED DESCRIPTION OF THE INVENTION

The invention is directed to creating a Bragg grating and, more specifically, an H-PDLC device having new and useful properties. A Bragg grating is a periodic arrangement within a material that interacts with light in accordance with Bragg's Law. By using an electric field to alter the optical thickness (nd) of the Bragg planes, variable wavelength response may be obtained from the device. The spectral characteristics of the Bragg grating, which depend on the optical thickness of the grating layers, can be manipulated in several ways. Firstly, the physical thickness of the grating planes can be controlled. Secondly, the index of each plane, which is a function of the LC composition and orientation of the LC component within each plane, may be modified. This invention is directed to the control of this second factor in a Bragg grating.

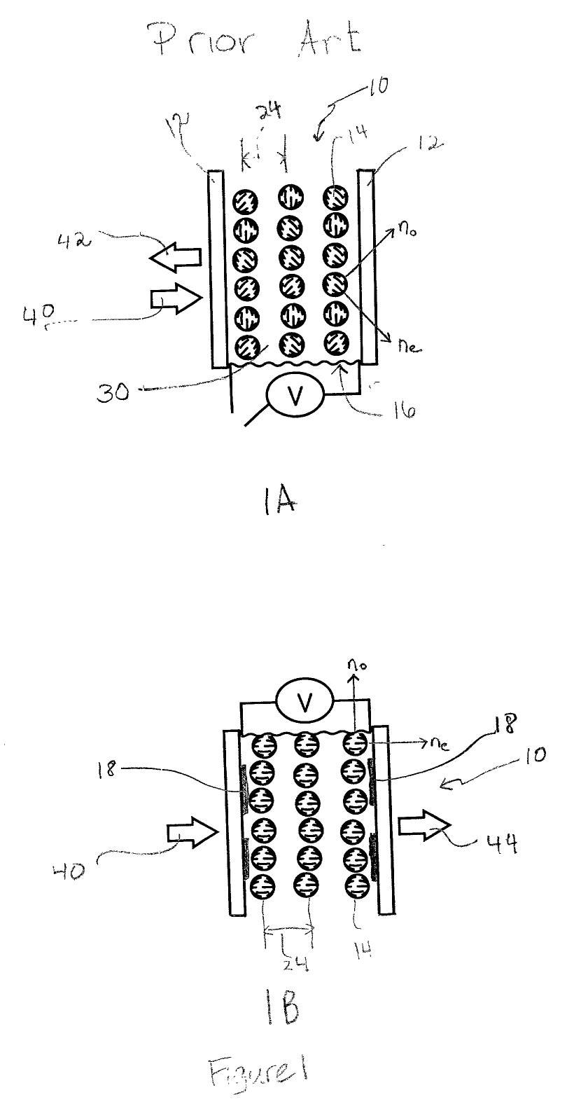

An H-PDLC is a phase-separated composition formed under holographic conditions. The composition is most typically prepared as a film, however, the composition may be prepared in any shape, form or size that permits exposure to the curing radiation. The holographic exposure induces formation of a periodic array of liquid crystal (LC) droplets and matrix polymer planes, as shown in FIG. 1. Upon illumination under holographic conditions, i.e., a light interference pattern, the monomer in high intensity light regions polymerizes and forces liquid crystal into dark regions. The liquid crystal remains in the dark regions and phase separates into small droplets on the order of nanometers, e.g., 10-200 nm, in ordered, stratified layers or array. The size of the droplets ultimately depends on mixture composition (relative monomer and liquid crystal composition and concentrations) and exposure conditions (e.g., light intensity, angle of cure and wavelength of curing radiation). For lower liquid crystal concentrations, spherical or ellipsoidal LC droplets are localized in stratified layers and are completely surrounded by matrix polymer. At higher liquid crystal concentrations, connectivity between the LC droplets may be observed. This is also known as a bicontinuous network. The coherent scattering occurs as either a reflected or a diffracted wavefront depending on the orientation of the grating. Small nanosized droplets are preferred because switching speed and haze from unwanted scattering are a function of droplet size.

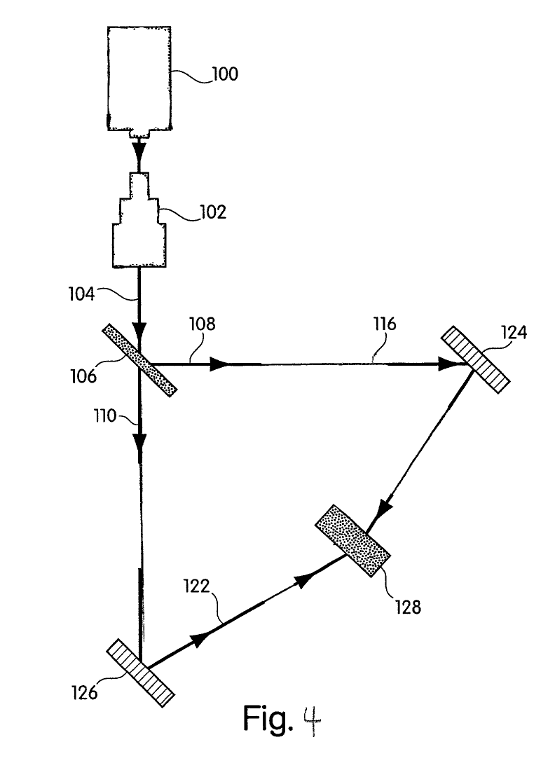

FIGS. 1A-1B are schematic illustrations of a multiple grating H-PDLC film 10 prepared by exposure to a holographic interference pattern, according to a method such as the one shown in FIG. 4. The film 10 is contained between two substrates 12 and includes liquid crystal droplets 14, associated with a reflective grating 24. The liquid crystal droplets 14 are localized in planes 16 in a polymer matrix 30. In one embodiment, substrates 12 are conductive or include a conductive coating, and may serve as electrodes for applying a potential across the H-PDLC material. In other embodiments, electrodes may be additionally included in the device. For example, metallic electrodes 18 may be positioned between the substrate 12 (now serving as a support) and the H-PDLC material 10 (see FIG. 1B).

The present invention relies upon index mismatching conditions (also known as “index modulation”) to shift the peak wavelength or alter the bandwidth of reflected or transmitted light. The principle is based on the Bragg equation, λ=2nd sinθ where n is the average index of refraction of the grating, θ is the angle between the substrate and viewing direction, and d is the Bragg layer spacing. Light incident on the H-PDLC film is reflected at a wavelength that is a function of the d-spacing of the LC layers, the index of the liquid crystal layer, and the orientation of the sample with respect to the light source. Thus, by modifying the refractive index of the liquid crystal, the characteristics of the reflected (or diffracted) light can be altered. Refractive index mismatch conditions can be selected to shift the wavelength of reflected light and modify its bandwidth.

A birefringent LC droplet possesses two characteristic refractive indices, oriented perpendicular to and parallel with the axis of LC droplet symmetry. The perpendicularly-oriented refractive index is known as the ordinary index, nₒ, and the parallel-oriented index is known as the extraordinary index, nₑ. These orientations are indicated for the LC droplets in FIG. 1A-1B. The ordinary refractive index, nₒ, of the LC droplet is approximately equal to the refractive index of the polymer matrix, nₚ, in traditional applications. The extraordinary refractive index of the LC droplet, nₑ, is greater than the ordinary refractive index, nₒ, i.e., nₑ>nₒ≈nₚ.

In conventional devices in the absence of an applied field, random orientation of the symmetry axes of the LC configuration exists within the LC droplets, as is shown in FIG. 1A. Thus, (n_{LC}) is the weighted average of the ordinary and extraordinary refractive indices (and residual polymer in the LC layers). (n_{LC}) is greater than nₒ and nₚ because it includes some component of nₑ. Thus, the system is index mismatched and incident light 40 is reflected or diffracted along the gratings (LC layers) of the H-PDLC film, shown as reflected light 42 in FIG. 1A.

When nₒ dominates the liquid crystal in the conventional system where nₒ≈nₚ, the index modulation along the optical axis is erased. In this case, incident light passes through the material without scatter or reflection, as is shown by transmitted light 44 in FIG. 1B, and the material appears transparent. This situation is attained by application of an electric field to orient the LC droplets so that nₒ, is parallel to the incident light, as is illustrated in FIG. 1B, which is the case for liquid crystals with a positive dielectric anisotropy.

This principle is exploited to produce H-PDLC devices that reflect various wavelengths of light, rather than being an on-off switch. According to the invention, the H-PDLC composite is selected such that index mismatch conditions exist under selected applied field strengths of the device. An index mismatch condition exists where the difference between the index values for (n_{LC}) and nₚ is sufficient to provide diffracted light of different wavelengths. The wavelength difference is of a magnitude sufficient to render it “useable” in the intended application. Useable differences will vary depending on the intended application. Thus, for optical display purposes, the wavelength differences should be detectable by the human eye and may be relatively large. For these purposes, the mismatch between indices may be at least about 5-10% (for today's materials), or the refractive indices differ by at least about 0.05-0.1. The nature of the diffracted light is a function of interaction length, as well as the refractive index. Particularly for telecommunication applications, where long interaction lengths are required, the index mismatch may be very small, e.g., orders of magnitude less than those required for optical display applications. In addition, many telecommunication applications require very small wavelength shifts in order to be functional, e.g., on the order of 1 nm, or less. In these cases, the index mismatch may be very small as well. Thus, the scope of the overall range of functional index mismatch is very large for this invention, and may range from as high as 0.1 (although no real upper limit is contemplated), to as low as 0.001, or even 0.0001, depending on the specific application.

Index mismatching of an H-PDLC can be manipulated in several ways. The index of each plane, which is a function of the LC composition and orientation of the LC component within each plane, may be controlled. This in turn depends on the index of the individual constituents of the composite and the degree to which they are separated during holographic formation. (n_{LC}) is a function of the degree of orientation of the LC droplets, with (n_{LC}) approaching nₚ, as the degree of orientation of the droplet is aligned parallel to the incident light direction. The difference in average refractive indices (index mismatch) results in the peak wavelength being lower for materials having a lower average refractive index.

Index mismatch be accomplished by appropriate selection of liquid crystal and polymer matrix and/or by appropriate selection of applied electric field strengths during operation of the device. The device may exhibit two or more distinct wavelengths of light, or it may display a continuum of light that varies with applied potential to the device. In some embodiments, the applied fields are of a strength sufficient to effect full alignment of LC droplets. In other embodiments, as will be explained in greater detail below, the applied field are of a strength that only partially aligns the LC droplets. Potentials typically used in the display and electro-optic switching industries, typically ranging from zero to 240V, are suitable for this purpose.

In one embodiment of the invention, the H-PDLC material components are selected such that index-mismatch is achieved. The polymer matrix possesses an index of refraction, nₚ, that is dissimilar to the ordinary index of the liquid crystal; that is, nₚ≠nₒ. Thus, when an electric field is applied to the display to fully orient the LC droplets, i.e., nₒ dominates, the display is still under index mismatch conditions. In some embodiments, nₚ may have a value intermediate to nₒ and nₑ. In other embodiments, nₚ may be greater than both LC indices. In still other embodiments, nₒ may be less than both LC indices. Both liquid crystal and polymer components may be selected to satisfy this criterion. It is not required, although it may be preferred, that one of the applied fields is zero.

In other embodiments, the applied fields may be selected such that an index mismatch condition is achieved. For example, the H-PDLC device may alternate between two potentials that orient the LC droplets to different degrees, so that different (n_{LC})'s are observed at the different potentials. These potentials are selected so that the (n_{LC})'s are index mismatched with nₚ. It is not required, although it may be preferred, that one of the applied fields is zero. Furthermore, it may be possible for nₒ to be substantially similar to nₚ, (nₒ≈nₚ), yet still have index mismatched at the switching voltages.

Consider for the purpose of illustration an H-PDLC device in which nₒ<nₚ<(n_{LC}) (at zero voltage). In this example, the H-PDLC would be driven from one reflecting state, through a non-reflecting state, to a second reflecting state at a shorter wavelength. This indicates that LC rich planes have a higher net index than the polymer planes at zero voltage. As the voltage is increased the index of the LC planes begins to drop until the index is matched to the polymer planes (zero reflection). All this time the optical thickness of the LC rich planes is shrinking due to the decrease in (n_{LC}) and, hence, the peak reflected wavelength is shifting to shorter wavelengths. At the index-matched voltage, (n_{LC})=nₚ, the LC molecules are not necessary parallel to the E-field and hence higher voltage will continue to change the optical response. Increased voltage now mismatches the indexes of the planes, this time with the LC plane index lower than the polymer index. In this embodiment the index of the polymer planes lies in between the ordinary index of the LC and the average LC index.

One can select materials sets in which the polymer index is higher or lower than both the average and ordinary LC index. In this case the H-PDLC will be switched between two reflecting states without passing an intermediate non-reflecting state. One can also select an LC material with a negative dielectric anisotropy. Such a material aligns perpendicularly to an electric field. Such a material would provide an H-PDLC device in which the reflected wavelength increases with increased voltage. One could also use an LC material that has a dielectric anisotropy that depends on the frequency of the applied field. Such a device could be switched between 3 states: an aligned (positive Δε), a randomly aligned, and an anti-aligned (negative Δε).

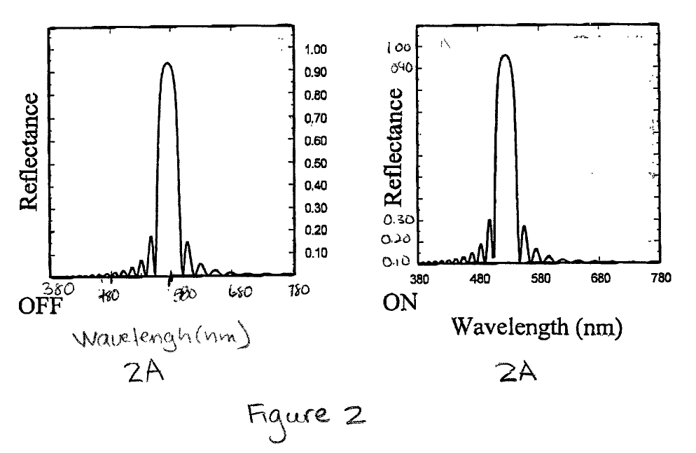

In the example of FIG. 2, coupled wave theory is used to numerically simulate index mismatch conditions. In FIG. 2A, a reflectance peak is shown centered at 576 nm, which occurs at zero applied field when the index of the polymer is nₚ=1.65 and the average index of the liquid crystal is (n_{LC})=1.8. The index mismatch is +0.15, where the positive sign is used to indicate that the liquid crystal has the higher index. When an electric field is applied, the average index of the liquid crystal plane changes to (n_{LC})=1.5 and the reflectance peak moves to 526 nm, as can be seen in FIG. 2B. The index mismatch is now −0.15. This represents a 50 nm shift in wavelength, going from yellow to cyan. For this particular example, it is interesting to note that at an intermediate potential, the condition n_{LC})=nₚ exists. Under this condition, the display is transparent and the viewer can observe the background, for example, a black background. Thus, three color states can exist for one display—cyan, black and yellow.

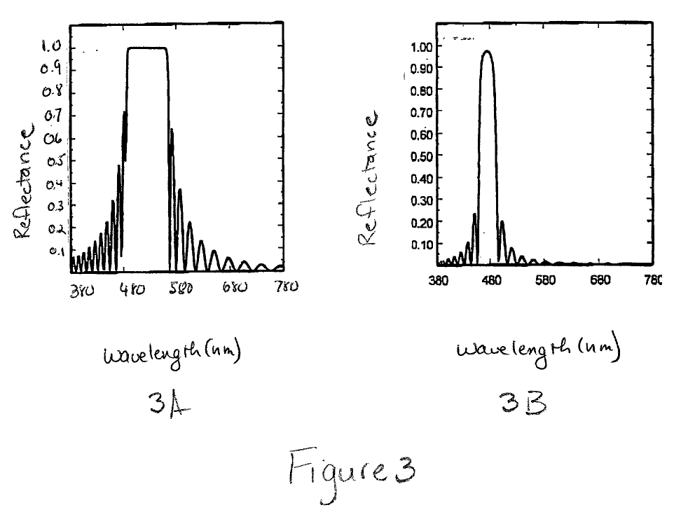

In another example shown in FIG. 3, the refractive index of the polymer is lower than any indices of the liquid crystal. For example, nₚ is equal to 1.35 and, in a zero field condition, (n_{LC}) is equal to 1.8 (index mismatch of +0.45). The display reflects a broad spectrum centered at about 530 nm as is shown in FIG. 3A. The broad spectrum in FIG. 3A is due inherently to the large index mismatch between the polymer and the liquid crystal. On application of an electric field, (n_{LC}) is reduced to 1.5 (index mismatch of +0.15), and the reflectance peak shifts 46 nm to about 480 nm, as is shown in FIG. 3B. This 46 nm shift in wavelength represents a shift from green to blue. For this particular example, the index matching conditions (n_{LC})=nₚ will never occur. It is interesting to note that the bandwidth, Δλ, is also varied in addition to the observed shift in reflection peak.

To prepare an H-PDLC film according to the invention, a two-beam interference pattern may be used to create a simple reflection or transmission grating. The grating is used to expose a composition containing monomer and liquid crystal in order to form the holographic grating. The composition may be deposited as a film or in any other desired form or shape using conventional methods. For example, the composition may be solvent casting or melt casting, or deposited by spin coating, silk screening, and the like. The orientation of the grating within the film determines whether or not the scattering occurs as reflected or diffracting light. This, in turn, is dependent upon the beam geometry during phase separation. In a preferred embodiment, a single laser source is used. The beam is split into a beam pair, which is directed so that the light beams interfere to produce the holographic light patterns used to create the reflection grating within the sample.

The method and apparatus is described with reference to FIG. 4. A laser light source 100 generates light of a predetermined wavelength and optionally is then passed through a beam expander and spatial filter 102. The resultant laser beam 104 is split into the number of beam pairs required for the particular application. Shown in FIG. 4, beam 104 is split using a beam splitter 106 into beams 108, 110. With the additional use of mirrors 124, 126, the laser beams are crossed to create a holographic light pattern. A sample 128 is located at the crossover points of beam pairs. Additional laser beams are used to create as many additional holographic patterns as are desired for a particular display application. It is observed that light of equal intensity forms holographic light of higher grating contrast leading to more efficient reflection gratings. The sample is exposed to light for a short time, typically in the range of 20-60 seconds. The exposure time strongly depends on laser power (intensity), the choice of monomer, dye and liquid crystal, as well as the relative concentrations of the materials.

Conventional liquid crystals and polymers may be used in the display devices of the current invention. Table 1 lists nₒ and Dₙ (birefringence, i.e. nₑ-nₒ) values for a variety of liquid crystals. Exemplary polymers include acrylated aliphatic urethanes such as dipentylerythritol hexa-/penta acrylate (Sigma-Aldrich), Ebecryl 8301, Ebecryl 4866, and Ebecryl 4883 (UCB Radcure), SR399 (Sartomer) and NOA 65 (Norland). Appropriate selections and combinations of materials can be made according to the teachings of this invention.

TABLE 1

| Liquid Crystal¹ | n₀ | Δn |
|---|---|---|
| E7 | 1.5211 | 0.2253 |
| BL038 | 1.5727 | 0.272 |
| TL205 | 1.527 | 0.2175 |

¹available from EM Industries

The invention may also be practiced with more complex H-PDLC structures, in which multiple gratings are incorporated into the H-PDLC film. Production of multiple gratings may be accomplished by simultaneously illuminating a precursor layer containing a photocurable monomer and a liquid crystal with two or more holographic light patterns capable of producing LC layers of different d-spacings. The crossing point of each laser beam pair is positioned and arranged so that a monomer-LC layer may be exposed to multiple holographic patterns in a single exposure. Multiple reflection gratings in a single layer are obtained thereby. A three beam interference pattern may also be used, in which case three gratings are formed which include two reflection gratings and one transmission grating. Details of the fabrication of such multiple grating films is found in co-pending application Ser. No. 09/398,964, entitled “Holographically-Formed Polymer Dispersed Liquid Crystals” and filed on Sep. 16, 1999, which is herein incorporated by reference.

The electrically controllable, variable wavelength devices of the invention find uses in display and telecommunications industries. Rapid growth of the Internet and other data traffic has caused explosive growth in fiber optic network technology. Fiber and waveguide gratings have become increasingly important in optical communications, for example, as Bragg gratings used to isolate individual channels in waveguide selective (WDM) networks.

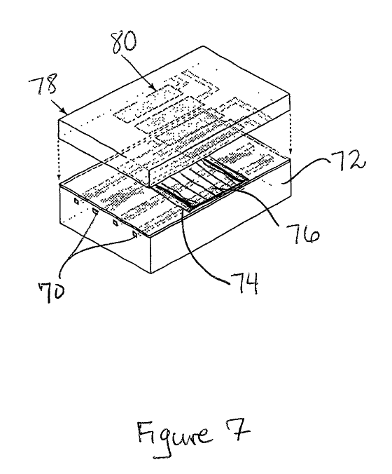

Optoelectronic devices incorporating the reflecting device of the invention may be prepared using standard optoelectronic manufacturing and packaging technology. An exemplary method of incorporating the reflective device of the invention into an optoelectronic device is shown in FIG. 7. The device includes optical fibers 70 located in channels of a base 72 such as silica onto which a lower electrode 74, here an ITO electrode, is positioned. A variably controllable reflecting H-PDLC film 76 contacts the lower electrode 74. An upper glass cover 78 includes upper electrodes 80, which are in contact with H-PDLC film when closed. Note that in some cases, ITO electrodes may be unsuitable due to the high index and resorptivity of ITO. Electric fields may be applied using metallic electrodes placed transverse or alongside the film 76.

Other uses for gratings include modulation of gain spectra for EDFA amplifiers, locking of pump lasers, etc. By combining optical switches with wavelength routing components such as fiber Bragg gratings, arrayed waveguide gratings or interference filters, it is possible to produce optical cross connects (OXC) for flexible control of multiwavelength traffic. The use of an ESGB (H-PDLC) in place of a typical passive fiber or waveguide Bragg grating adds the property of switchability, combining the properties of an optical switch with a filter. Potential applications include switchable add/drop filters, optical cross-connects, dynamic equalizers, tunable attenuators, tunable filters, and other optical networks.

H-PDLC materials can meet the material parameters for both display devices and ESGBs in waveguide geometries. Whereas transmission holograms require large spatial index modulations (>0.03) for high diffraction efficiencies over short (10 to 30 μm) interaction lengths, waveguide gratings intended to function as narrow band filters (<0.5 nm at 1550 nm) typically need quite small index modulations (≈5×10⁻⁴) over path lengths of about 5000 μm. These parameters are achievable by appropriate selection of polymer and liquid crystal and use of the appropriate holographic light.

The invention is described in the following examples, which are presented for the purpose of illustration only and which are not limiting of the invention, the full scope of which is found in the claims that follow.

### EXAMPLE 1

A blended monomer system was prepared by mixing Ebecryl 4866 with Ebecryl 8301 (both from UCB Radcure) in a ratio of 2:1. This was then mixed with the liquid crystal BL038 (EM Industries) and a solution of Rose Bengal and N-phenylglycine in 1-vinyl-2-pyrrolidone. Weight ratios were 50:36:14 for the monomers:LC:solution respectively. This was homogenized and then mixed with Tergitol Min-Foam 1X surfactant from Union Carbide (3 wt. %). An H-PDLC was then formed between conducting ITO-glass substrates using this mixture. The surfactant was used to lower the switching voltage and also can slightly modify the index of refraction.

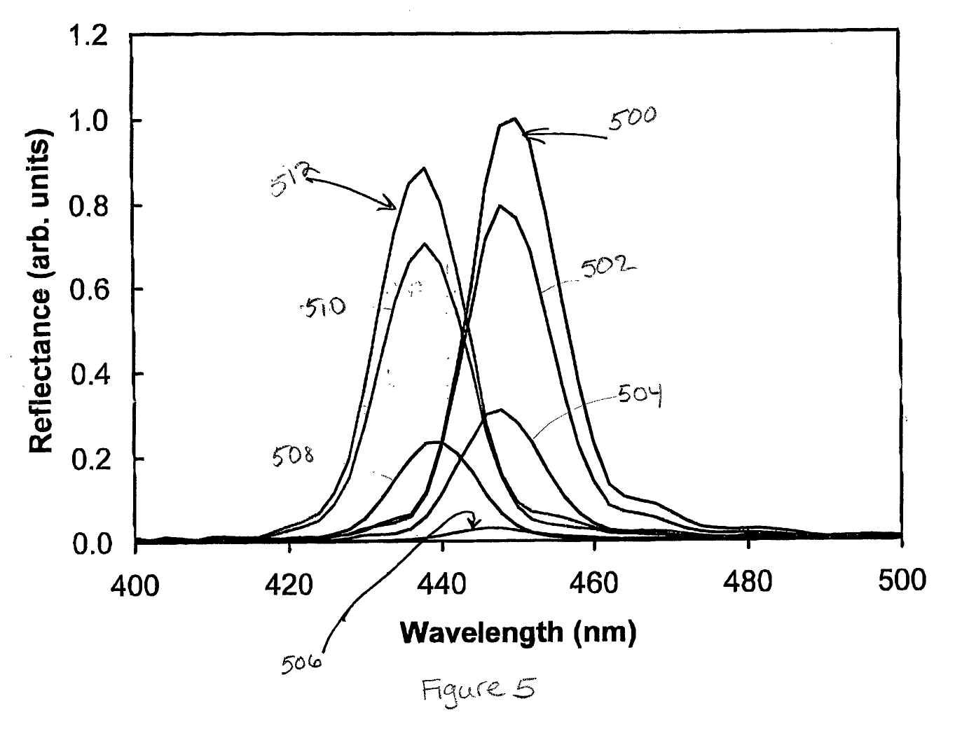

The electro-optic response of this H-PDLC is shown in FIG. 5. In the resting (zero voltage) state (curve 500) the reflectance peak is at 450 nm. As the applied voltage is increased to 40 V, 80V and 120 V (curves 502, 504, 506, respectively), the reflectance falls to a minimum at 120 V (curve 506). At this stage the peak wavelength is at 446 nm, and contrast is approximately 32:1. As the applied voltage is increased beyond 120 V to 160 V and 200 V (curves 508, 510, respectively), the peak reflectance begins to increase and continues to shift to shorter wavelengths. At 240 V (curve 512), the peak reflected intensity is approximately equal to the 0 V reflectance. The peak wavelength at 240 V is 438 nm, indicating a 12 nm shift.

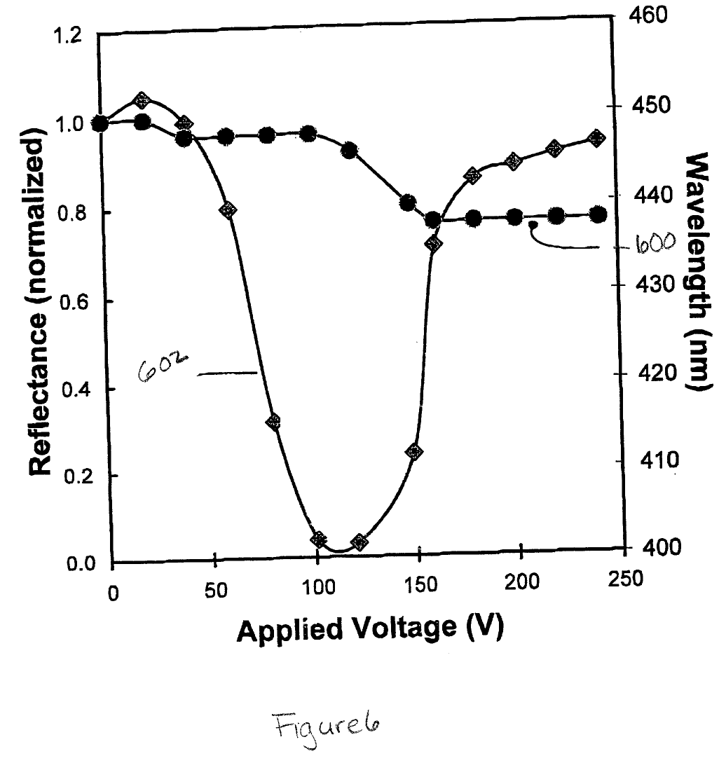

These results are illustrated graphically in FIG. 6, where the left vertical axis shows wavelength (nm). From the figure, the shift in the wavelength as a function of voltage is clearly observable (curve 600). At 0V, there is a strong reflection at around 450 nm. At around 110 V, the index matching is achieved and reflection is nearly diminished, and a 240 V, the reflection peak again arises at 438 nm. A 12 nm shift occurred for this sample. On the right axis, the wavelength shift is plotted as a function of voltage (curve 602), which starts at 450 nm (0V) and ends at 438 nm (240V). The device is fully transmissive (translucent) at about 110 V.

What is claimed is:

1. A reflecting device having electrically controllable, variable reflection, comprising:
a composition comprising a periodic array of liquid crystal disposed in a polymer matrix, the liquid crystal having an index of refraction that is variable in response to an applied electric field, wherein the index of refraction of the liquid crystal array and the index of refraction of the polymer matrix, nₚ, are mismatched at said first and second applied electric field strength; and
a pair of electrodes positioned to apply an electric field across the composition and capable of applying the first and second applied electric field strengths.

2. The reflecting device of claim 1, wherein the first applied electric field strength is zero.

3. The reflecting device of claim 1 or 2, wherein the second applied electric field strength is sufficient to substantially align the liquid crystal droplets.

4. The reflecting device of claim 1, wherein the device possesses at least two reflection wavelengths, each reflection wavelength associated with a different applied field strength.

5. The reflecting device of claim 1, wherein the liquid crystal has an ordinary index of refraction, nₒ, and an extraordinary index of refraction, nₑ, and the polymer has a refractive index, nₚ, and where nₒ≠nₚ.

6. The reflecting device of claim 1, wherein the liquid crystal has an ordinary index of refraction, nₒ, and an extraordinary index of refraction, nₑ, and the polymer has a refractive index, nₚ, and where nₑ>nₚ>nₒ.

7. The reflecting device of claim 1, wherein the liquid crystal has a positive dielectric anisotropy.

8. The reflecting device of claim 1, wherein the liquid crystal has a negative dielectric anisotropy.

9. The reflecting device of claim 1, wherein the liquid crystal has a dielectric anisotropy dependent upon applied field frequency.

10. The reflecting device of claim 1, wherein the device is selected from the group consisting of waveguide gratings, switchable lenses, switchable filters, optical add-drop multiplexers and attenuators.

11. The reflecting device of claim 1, further comprising:
a power source in electrical communication with the electrodes for generating the electric field.

12. The reflecting device of claim 1, wherein the electrode comprises a conductive layer in electrical communication with the composition.

13. The reflecting device of claim 12, wherein the conductive layer comprises indium titanium oxide (ITO).

14. The reflecting device of claim 1, wherein the electrode comprises a metallic electrode.

15. A reflecting device having electrically controllable, variable reflection, comprising:
first and second electrodes having a holographic polymer dispersed liquid crystal (H-PDLC) film disposed therebetween, the H-PDLC film comprised of layers of liquid crystal and polymer matrix, the liquid crystal layer having a first average index of refraction, (n_{LC})₁, at a first applied electric field strength and a second average index of refraction, (n_{LC})₂, at a second applied electric field strength, wherein the (n_{LC})'s of the liquid crystal and the index of refraction of the polymer matrix, nₚ, are mismatched at both the first and second applied electric field strengths.

16. The reflecting device of claim 15, wherein the first applied electric field strength is zero.

17. The reflecting device of claim 15 or 16, wherein the second applied electric field strength is sufficient to substantially align the liquid crystal droplets.

18. The reflecting device of claim 15, wherein the liquid crystal further comprises a third (n_{LC}) substantially equal to nₚ at a third applied electric field strength.

19. The reflecting device of claim 15, wherein the device possesses at least two reflection wavelengths, each reflection wavelength associated with a different applied field strength.

20. The reflecting device of claim 15, wherein the device possesses at least three different color states, each color state associated with a different applied field strength.

21. The reflecting device of claim 15, wherein the index mismatching conditions results in a shift in the bandwidth of reflected light, as the device liquid crystal moves from a state having a (n_{LC})₁ to a state having a (n_{LC})₂.

22. The reflecting device of claim 15, wherein the liquid crystal has an ordinary index of refraction, nₒ, and an extraordinary index of refraction, nₑ, and the polymer has a refractive index, nₚ, and where nₒ≠nₚ.

23. The reflecting device of claim 15, wherein the liquid crystal has a positive dielectric anisotropy.

24. The reflecting device of claim 15, wherein the liquid crystal has a negative dielectric anisotropy.

25. The reflecting device of claim 15, wherein the liquid crystal has a dielectric anisotropy dependent upon applied field frequency.

26. The reflecting device of claim 15, wherein the device is selected from the group consisting of waveguide gratings, switchable lenses, switchable filters, optical add-drop multiplexers and attenuators.

27. The reflecting device of claim 15, further comprising:
a power source in electrical communication with the electrodes for generating the electric field.

28. The reflecting device of claim 15, wherein the electrode comprises a conductive layer in electrical communication with the composition.

29. The reflecting device of claim 28, wherein the conductive layer comprises indium titanium oxide (ITO).

30. The reflecting device of claim 15, wherein the electrode comprises a metallic electrode.

31. A grating having electrically controllable, variable peak wavelength, comprising:
a periodic array of diffractive planes in a supporting matrix, said planes forming a grating spaced at a distance on the order of a wavelength of light and having an optical thickness responsive to an applied electric field;
first and second electrodes for applying first and second applied electric field strengths across the grating,
wherein the first and second electric field strengths alter optical thickness to alter peak wavelength of reflected light.

32. A reflecting device having electrically controllable, variable reflection, comprising:
a periodic array of liquid crystals disposed in a polymer matrix, the liquid crystal having an index of refraction variable in response to an applied electric field; and
means for applying an electric field across the device to provide first and second applied electric field strengths,
wherein index of refraction of the liquid crystal and the index of refraction of the polymer matrix, nₚ, are mismatched at said first and second applied electric field strengths.

33. A method of varying the optical thickness of a reflecting device, comprising:
providing a reflecting device comprising a periodic array of liquid crystal in a polymer matrix, the liquid crystal array having an index of refraction variable in response to an applied electric field; and
altering the electric field strength across the H-PDLC film between the first and second applied electrical field strengths, wherein the indices of refraction of the liquid crystal are mismatched with the index of refraction of the polymer matrix at both the first and second applied electrical field strengths.

34. The method of claim 33, wherein the reflecting device comprises first and second substrates having a holographic polymer dispersed liquid crystal (H-PDLC) film disposed therebetween, the H-PDLC film comprised of layers of liquid crystal and polymer matrix.

35. The method of claim 33, wherein the liquid crystal has an ordinary index of refraction, nₒ, and an extraordinary index of refraction, nₑ, and the polymer has a refractive index, nₚ, and where nₒ≠nₚ.

36. The method of claim 33, wherein the peak wavelength of the reflected light shifts as the liquid crystal moves from a state having a first average index of refraction at the first applied electric field strength to a state having a second average index of refraction at the second applied electric field strength.

37. The method of claim 33, wherein the device exhibits a continuum of reflection wavelengths as the applied field strength is varied between the first and second applied field strengths.

38. The method of claim 33, wherein the reflection wavelength shifts to lower wavelength as the field strength is increased.

39. The method of claim 37, wherein the reflection wavelength shifts to higher wavelength as the field strength is increased.

40. The method of claim 33, wherein the bandwidth of reflected light varies as the applied field strength is varied between the first and second applied field strengths.

41. The method of claim 33, wherein the applied field strength is of sufficient strength to align the liquid crystal droplets to an extent sufficient to alter the LC index of refraction.

42. The method of claim 33 or 41, wherein the first applied electric field strength is zero.

43. The method of claim 33 or 41, wherein the applied electric field strength is in the range of about 0V to 240 V.

44. The method of claim 33, wherein the liquid crystal further comprises a third average index of refraction substantially equal to the index of refraction of the polymer crystal.

45. A method of modifying reflection characteristics in an H-PDLC reflecting device, comprising:
providing a reflecting device comprising first and second substrates having a holographic polymer dispersed liquid crystal (H-PDLC) film disposed therebetween, the H-PDLC film comprised of layers of liquid crystal and polymer matrix, the liquid crystal having an average index of refraction, n_{LC}, and the polymer having an index of refraction, nₚ; and
altering the electric field strength across the H-PDLC film to vary the index of refraction of the liquid crystal such that the H-PDLC film moves from a first index mismatch condition to a second index mismatch condition, each said index mismatch condition associated with a characteristic reflection characteristic of the H-PDLC film.

46. The method of claim 45, wherein the step of moving from a first index mismatch condition to a second index mismatch condition comprises moving through a index matching condition.

47. A method of electrically controlling a variable peak wavelength of a grating, comprising:
a periodic array of diffractive planes in a supporting matrix, said planes forming a grating spaced at a distance on the order of a wavelength of light and having an optical index responsive to an applied electric field; and
applying first and second applied electric field strengths to alter the peak wavelength of the grating.
